(19) United States
(12) Patent Application Publication
(10) Pub. No.: US 2022/0128439 A1
(43) Pub. Date: Apr. 28, 2022

(54) DEVICE AND METHOD FOR HIGH PRESSURE AND STEAMING HEAT-INDUCED ANTIGEN RETRIEVAL

(71) Applicant: General Hospital of Ningxia Medical University, Ningxia (CN)

(72) Inventors: Yan XIE, Ningxia (CN); Jiaxiang MA, Ningxia (CN); Fang ZHAO, Ningxia (CN); Xiaoliang PAN, Ningxia (CN); Lifeng GUAN, Ningxia (CN); Wei ZHOU, Ningxia (CN)

(21) Appl. No.: 17/264,408

(22) PCT Filed: Sep. 16, 2020
(86) PCT No.: PCT/CN2020/115658

§ 371 Date: Jan. 29, 2021

(30) Foreign Application Priority Data
Jul. 16, 2019 (CN) 201910641536.4

(51) Int. Cl. G01N 1/31; G01N 1/44

(52) U.S. Cl. CPC G01N 1/312; G01N 1/44

(57) ABSTRACT

The disclosure describes a device and a method for high pressure and steaming heat-induced antigen retrieval. The device comprises a lower support mechanism, an isolation mechanism, a loading mechanism, a slide loading mechanism and a positioning mechanism, wherein the loading mechanism comprises at least two slide loading trays; the isolation mechanism comprises at least one upright post; and the at least two slide loading trays are sequentially arranged from bottom to top. The slide loading mechanism comprises at least one slice fixation box, and a slide glass and a cover glass arranged in the slice fixation box. The cover glass is placed on the upper surface of the slide glass, and the tissue to be retrieved is placed between the slide glass and the cover glass. A limiting hole is formed in the middle of the slide loading tray, and a plurality of air holes are formed in the slide loading tray.

### FIELD

This invention relates to the technical field of tissue antigen retrieval, in particular to a device and a method for high pressure and steaming heat-induced antigen retrieval.

### BACKGROUND

In the immunohistochemical staining process, in order to fully expose antigen, increase tissue permeability, promote binding of antigen and antibody and make antigen fully chromogenic, it is necessary to retrieve the antigen. At present, the common method is to immerse the slice with tissue into retrieval solution. However, this method is extremely easy to lead to immunohistochemistry staining abort due to tissue detachment.

### SUMMARY

The difficulties and drawbacks associated with previous approaches are addressed in the present subject matter as follows.

In one aspect, the present disclosure provides a device for high pressure and steaming heat-induced antigen retrieval. The device comprises a lower support mechanism, an isolation mechanism, a loading mechanism, a slide loading mechanism and a positioning mechanism. The lower support mechanism has a lower end that is placed inside an external high-pressure heating device, and an upper end at which the loading mechanism is placed. The loading mechanism comprises at least two slide loading trays. The isolation mechanism comprises at least one upright post. The at least two slide loading trays are arranged sequentially from bottom to top. The upright post is arranged between two adjacent slide loading trays. The slide loading mechanism comprises at least one slice fixation box, and a slide glass and a cover glass arranged in the slice fixation box. The cover glass is placed on an upper surface of the slide glass, and tissue to be retrieved and retrieval solution are placed between the slide glass and the cover glass. A limiting hole is formed in a middle of each slide loading tray. The positioning mechanism has a lower end that is inserted through the limiting hole of each slide loading tray, and an upper end that is located above a slide loading tray in a top layer, and a plurality of air holes are formed on the slide loading tray.

In another aspect, the present disclosure provides a method for high pressure and steaming heat-induced antigen retrieval. The method is applied in a device for high pressure and steaming heat-induced antigen retrieval as described herein. The method for high pressure and steaming heat-induced antigen retrieval includes dripping 1 ml of retrieval solution onto a slide glass that carries tissue, covering a cover glass, and placing two ends of the cover glass on a left half body and a right half body of a slice fixation box. The method also includes placing a slide loading tray in a bottom layer in an external high-pressure heating device, injecting retrieval solution in the external high-pressure heating device, and placing on the slide loading tray a plurality of slice fixation boxes on which slide glasses are placed. The method also includes placing a slide loading tray and a slice fixation box, on which a slide glass is placed, in the next upper layer sequentially. The method also includes starting the external high-pressure heating device to provide the tissue with hot steam at a pressure above a pressure threshold and a temperature above a temperature threshold, to retrieve the tissue.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a structural schematic diagram of a device for high pressure and steaming heat-induced antigen retrieval of some embodiments of the present disclosure.

FIG. 2 is a structural schematic diagram of a slide loading tray in some embodiments of the present disclosure.

FIG. 3 is a structural schematic diagram of a slide loading tray in some embodiments of the present disclosure.

FIG. 4 is a top view of a slide loading mechanism in some embodiments of the present disclosure.

FIG. 5 is a front view of a slide loading mechanism in some embodiments of the present disclosure.

FIG. 6 is a right view of a left half body in some embodiments of the present disclosure.

FIG. 7 is a schematic diagram in which tissue and retrieval solution are placed in a slide loading mechanism in some embodiments of the present disclosure.

FIG. 8 is a structural schematic diagram of a lower support mechanism in some embodiments of the present disclosure.

### DETAILED DESCRIPTION OF THE EMBODIMENTS

It is necessary to provide a device for high pressure and steaming heat-induced antigen retrieval.

It is also necessary to provide a method for high pressure and steaming heat-induced antigen retrieval.

According to one aspect of the embodiments of the present disclosure, a device for high pressure and steaming heat-induced antigen retrieval, comprises a lower support mechanism, an isolation mechanism, a loading mechanism, a slide loading mechanism and a positioning mechanism. The lower support mechanism has a lower end that is placed inside an external high-pressure heating device, and an upper end at which the loading mechanism is placed. The loading mechanism comprises at least two slide loading trays. The isolation mechanism comprises at least one upright post. The at least two slide loading trays are arranged sequentially from bottom to top. The upright post is arranged between two adjacent slide loading trays. The slide loading mechanism comprises at least one slice fixation box, and a slide glass and a cover glass arranged in the slice fixation box. The cover glass is placed on an upper surface of the slide glass, and tissue to be retrieved and retrieval solution are placed between the slide glass and the cover glass. A limiting hole is formed in the middle of each slide loading tray. The positioning mechanism has a lower end that is inserted through the limiting hole of each slide loading tray, and an upper end that is located above the slide loading tray in a top layer, and a plurality of air holes are formed on the slide loading tray.

In some embodiments, an upper surface and a lower surface of the slide loading tray are provided with inward concave positioning counter bores close to edges, and an end of the upright post is clamped in one of the positioning counter bores.

In some embodiments, the slice fixation box comprises a left half body and a right half body which are oppositely arranged. Each of the left half body and the right half body is provided with a stepped groove for placing an end of the slide glass. There is a distance between a bottom wall of the stepped groove and the upper surface of the slide loading tray, so that the slide glass between the left half body and the right half body does not contact the upper surface of the slide loading tray.

In some embodiments, the stepped groove has a height of at least 1 mm.

In some embodiments, an upper surface of the slide glass and a lower surface of the cover glass are oppositely arranged, and are both smooth flat surfaces.

In some embodiments, the positioning mechanism comprises an elongated strip-shaped body that can be extended or retracted with an adjustable height, and the upright post of the lower support mechanism can be extended or retracted with an adjustable height.

In some embodiments, the device for high pressure and steaming heat-induced antigen retrieval further comprises a drip tray that is a tray body, which has an opening at a top and in which retrieval solution for providing steam is contained, retrieval solution for immersing tissue between the slide glass and the cover glass is consistent with the retrieval solution in the drip tray.

In some embodiments, the retrieval solution for immersing tissue between the slide glass and the cover glass and the retrieval solution in the drip tray are both sodium citrate retrieval solution.

According to another aspect of the embodiments of the present disclosure, a method for high pressure and steaming heat-induced antigen retrieval is provided, which is applied in the device for high pressure and steaming heat-induced antigen retrieval as described above, wherein the method includes the following steps.

The method includes dripping 1 ml of retrieval solution onto the slide glass that carries tissue, covering the cover glass, and placing two ends of the cover glass on the left half body and the right half body of the slice fixation box.

The method also includes placing a slide loading tray in a bottom layer in an external high-pressure heating device, injecting retrieval solution in the external high-pressure heating device, and placing on the slide loading tray a plurality of slice fixation boxes on which slide glasses are placed.

The method also includes placing a slide loading tray and a slice fixation box, on which a slide glass is placed, in the next upper layer sequentially.

The method also includes starting the external high-pressure heating device to provide the tissue with hot steam at a pressure above a pressure threshold and a temperature above a temperature threshold, to retrieve the tissue.

In some embodiments, retrieval solution injected in the external high-pressure heating device is consistent with the retrieval solution for immersing the tissue between the slide glass and the cover glass.

In the embodiments of the present disclosure, the tissue permeability and the success rate of immunohistochemistry can be effectively improved by high-pressure steaming heat-induced antigen retrieval. Heat-induced retrieval of multiple slices can be performed at the same time and the number of samples during one retrieval process can be increased by placing the slices on multiple slide loading trays in multiple layers. The slices of tissue are placed horizontally and the slide glass and the cover glass are fixed in position by the slice fixation box, which effectively prevents the violent impact of boiled retrieval solution on tissue.

The device and the method for high pressure and steaming heat-induced antigen retrieval provided by the embodiments of the present disclosure can effectively prevent tissue detachment during antigen retrieval.

In order to describe the technical solution in the embodiments of the present disclosure more clearly, the drawings which are required to be used in the embodiments will be briefly described below. The drawings described below are only some embodiments of the present disclosure, and other drawings can be obtained by those skilled in the art based on these drawings without any creative efforts.

In the figures, the following are illustrated: a lower support mechanism 10, an upright post 20, a slide loading tray 30, an air hole 31, a positioning counter bore 32, a slide loading tray gripper 33, a limiting hole 34, a slide loading mechanism 40, a slice fixation box 41, a left half body 411, a right half body 412, a stepped groove 413, a slide glass 42, a cover glass 43, an elongated strip-shaped body 50, a disc holder 51, a drip tray 60, a retrieval solution 70, a pressure cooker 100 and tissue 200.

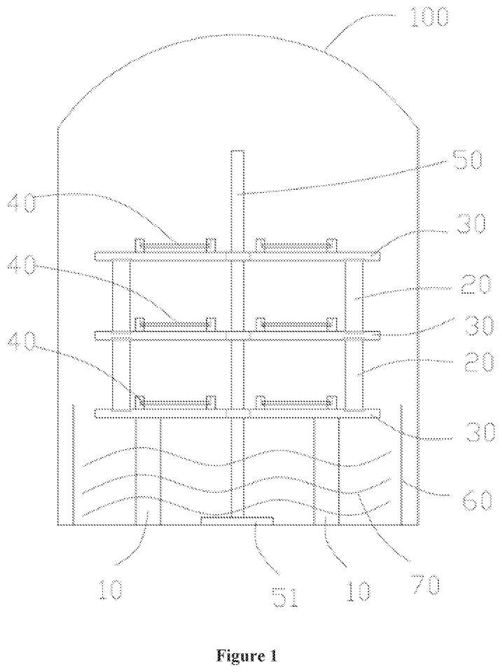

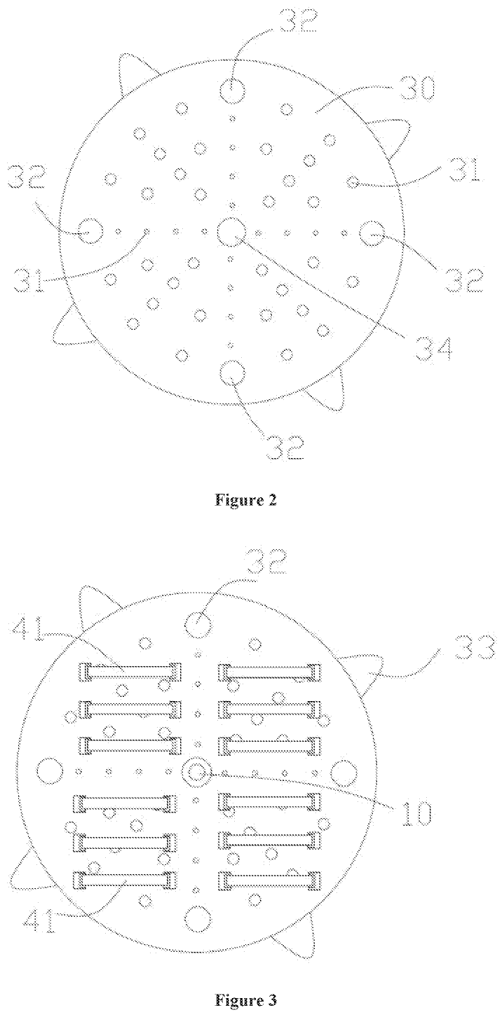

Referring to FIGS. 1, 2 and 3, the embodiment of the present disclosure provides a device for high pressure and steaming heat-induced antigen retrieval, which comprises a lower support mechanism 10, an isolation mechanism, a loading mechanism, a slide loading mechanism 40 and a positioning mechanism. The lower end of the lower support mechanism 10 is configured to be placed in an external high-pressure heating device. For example, the external high-pressure heating device is a pressure cooker 100. When the lower end of the lower support mechanism 10 is placed in the pressure cooker 100, the isolation mechanism, the loading mechanism, the slide loading mechanism 40 and the positioning mechanism are also located in the pressure cooker 100. The loading mechanism is arranged at the upper end of the lower support mechanism 10, and comprises at least two slide loading trays 30. The isolation mechanism comprises at least one upright post 20, the two slide loading trays 30 are arranged sequentially from bottom to top, and the upright post 20 is arranged between the two adjacent slide loading trays 30 to isolate the two adjacent slide loading trays 30 from each other. FIG. 3 shows a structural schematic diagram in which a slice fixation box 41 is attached on the slide loading tray 30. The slide loading mechanism 40 comprises at least one slice fixation box 41, and a slide glass 42 and a cover glass 43 which are arranged in the slice fixation box 41. The cover glass 43 is arranged on the upper surface of the slide glass 42, and tissue to be retrieved 200 is placed between the slide glass 42 and the cover glass 43. In addition, a limiting hole 34 is formed in the middle of the slide loading tray 30, and the lower end of the positioning mechanism is inserted through the limiting hole 34 of each slide loading tray 30. The upper end of the positioning mechanism is located above the slide loading tray 30 in a top layer, and a plurality of air holes 31 are formed in the slide loading tray 30. Wherein, the lower support mechanism 10 is a long cylinder.

In this device for high pressure and steaming heat-induced antigen retrieval, the slide loading tray 30 in a bottom layer is isolated from the bottom by the lower support mechanism 10, so that the retrieval solution 70 is prevented from contacting the slide loading tray 30, and the heat-induced retrieval of the tissue 200 is further realized by steam. A plurality of slide loading trays 30 are arranged in the device, and are isolated from each other by using the upright posts 20. At least 6 to 12 or more slide loading mechanisms 40 can be arranged in each layer, so that not only the number of samples in each heat-induced retrieval of tissue 200 increases, but also the upright posts 20 between the adjacent slide loading trays 30 can be movably placed and disassembled, which is different from the integral multi-layer structure design. In the embodiments of the present disclosure, each layer of the movably placed slide loading tray 30 can be taken out from or put into it. When the slice fixation box 41 is placed, the tissue 200 and retrieval solution 70 have been placed between the slide glass 42 and the cover glass 43, and the tissue 200 has been immersed in the retrieval solution 70. Thus, when the slice fixation box 41 is placed on the slide loading tray 30, the slice fixation box 41 needs to be placed horizontally. In operation, the slide loading tray 30 in a bottom layer is placed first, and then, 6 to 12 slice fixation boxes 41 are placed on the slide loading tray 30 from above the slide loading tray 30 while keeping horizontal. Then, the slide loading tray 30 in the second layer is placed, and a plurality of slice fixation boxes 41 are sequentially placed on the slide loading tray 30 in the second layer from above, i.e., a plurality of slice fixation boxes 41 are placed on the slide loading tray 30 in the second layer from above the slide loading tray 30 while keeping horizontal. In terms of the integral multi-layer structure whose slide loading tray is not detachable, during the placement of the slice fixation box, it is necessary to insert the slice fixation box above the slide loading tray from the side, which makes it difficult to ensure its horizontality and is easy to tilt, so that the retrieval solution between the slide glass and the cover glass flows out. Therefore, In the embodiments of the present disclosure, detachment of tissue can be effectively prevented.

Wherein, the plurality of air holes 31 comprise a plurality of large holes and a plurality of small holes. The diameters of the large holes are bigger than those of the small holes.

In some embodiments, the upper surface and the lower surface of the slide loading tray 30 are provided, i.e., opened, with inward concave positioning counter bores 32 close to the edges, and an end of the upright post 20 is clamped in one of the positioning counter bores 32.

The arrangement of the upright posts 20 enables the detachable assembly between the adjacent slide loading trays 30. In a high-pressure and high-temperature state, the retrieval solution 70 is in a boiling state, and thus steam of the retrieval solution 70 can cause certain impact forces on the slide loading trays 30. If the upright posts 20 are in plane contact with the surfaces of the slide loading trays 30, there may be dislocation or sliding movement between the slide loading trays 30 and the upright posts 20. Therefore, the relative positions of the upright posts 20 and the slide loading trays 30 are limited through the positioning counter bores 32, so that the slide loading trays 30 are prevented from slipping due to steam impact. The upright posts 20 not only facilitate the detachable assembly between the adjacent slide loading trays 30, but also limit the positions of the slide loading trays 30 by positioning counter bores 32, so as to avoid the problem of easy dislocation or sliding movement between the slide loading trays 30 and the upright posts 20.

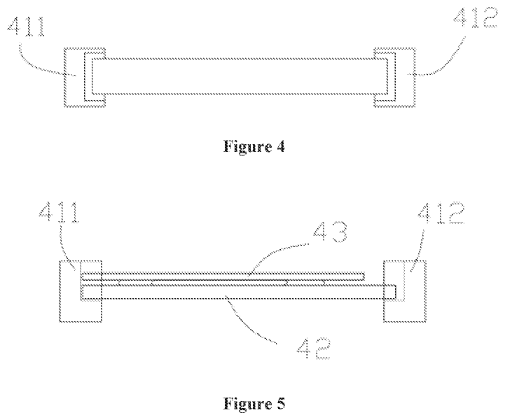

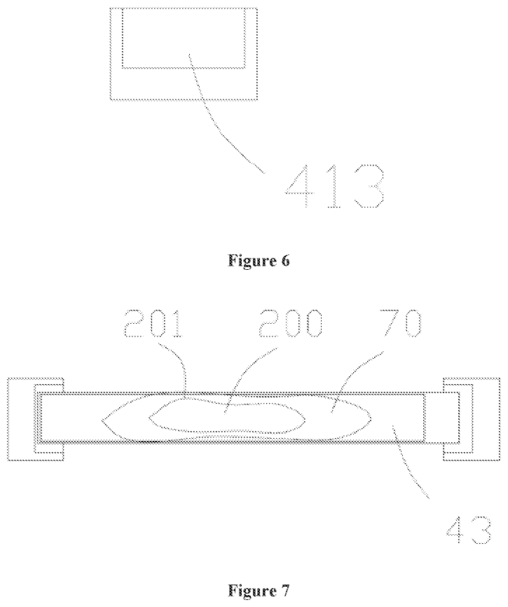

As shown in FIG. 4, FIG. 5 and FIG. 6, in some embodiments, the slice fixation box 41 comprises a left half body 411 and a right half body 412 which are oppositely arranged, each of the left half body 411 and the right half body 412 is provided with a stepped groove 413 for placing an end of the slide glass 42. The bottoms of the left half body 411 and the right half body 412 are in contact with the upper surface of the slide loading tray 30, and there is a distance between the bottom wall of the stepped groove 413 and the upper surface of the slide loading tray 30, so that the slide glass 42 between the left half body 411 and the right half body 412 is not contacted, i.e., effectively isolated, with the surface of the slide loading tray 30. In some embodiments, the height of the stepped groove 413 is at least 1 mm, and the air holes 31 of the slide loading tray 30 are not blocked.

In operation, the slide glass 42, the tissue 200 and the slide glass 43 are placed in the slice fixation box 41 first, and then the slice fixation box 41 is placed on the slide loading tray 30. In this way, the slide glass 42, the slide glass 43 and the tissue 200 can be operated in advance separately outside the slide loading tray 30. Moreover, the stepped grooves 413 of the left half body 411 and the right half body 412 limit the relative displacement of the slide glass 42 and the cover glass 43, and therefore, the relative sliding and dislocation between the slide glass 42 and the cover glass 43 can be avoided. Then, the slice fixation box 41 is placed on the slide loading tray 30. This is completely different from the operation without the slice fixation box. Without the slice fixation box, the operator can only place the slide glass on the slide loading tray, and then place the tissue and drip the retrieval solution, and finally cover the cover glass. In this way, because the operator is outside but the slide loading tray is inside the pressure cooker, it is impossible to observe and operate them closely, which leads to a large error. Or, if the operator holds the edge of the slide glass and moves it on the slide loading tray after placing the above three elements from outside, the slide glass and the cover glass can easily be dislocated and slide without the restriction of the slice fixation box during movement. In some embodiments, the tissue has been placed on the slide glass in advance before the slide glass is placed on the slide loading tray.

In some embodiments of the present application, the left half body 411 and the right half body 412 have a certain thickness, and the bottom areas of the left half body 411 and the right half body 412 are small, so that the slide glass 42 is not directly contacted with the slide loading tray 30 and the air holes 31 are not blocked after the slide glass 42 is placed, and therefore, the steam can flow up and down smoothly. However, if the slide glass is directly contacted with the slide loading tray, the air flow of the steam can impact the slide glass to displace. Therefore, in the embodiments of the present disclosure, the arrangement of the left half body 411 and the right half body 412 has remarkable effects.

In one single-layer design for a slide loading tray adopted in the prior art, there are only small number of samples, and the slide glass is directly placed on the slide loading tray.

In the embodiments of the present disclosure, the upper surface of the slide glass 42 and the lower surface of the cover glass 43 are placed opposite to each other, and are both smooth flat surfaces. In some embodiments, the upper surface of the slide glass 42 and the lower surface of the cover glass 43 are closely contacted with each other. The tissue 200 to be retrieved is placed between the slide glass 42 and the cover glass 43, and is immersed in the retrieval solution 70, and the retrieval solution 70 is liquid. After the tissue 200 is immersed, the solution between the slide glass 42 and the cover glass 43 is not easily diffused outwards due to mutual attraction between molecules on the surface of the solution, thereby ensuring that there is no sliding movement and dislocation between the slide glass 42 and the cover glass 43, and the tissue 200 is not easily exposed to the outside of the retrieval solution 70. In the scheme that the lower surface of the cover glass is a rough surface, a plurality of bubbles are present between the retrieval solution and the rough surface, the bubbles are very active under the action of high-temperature steam and easily enter the interior of the retrieval solution and then come into contact with the tissue, so that the surface of the tissue is not uniformly heated.

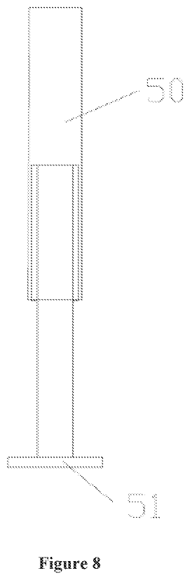

As shown in FIG. 8, in some embodiments, the positioning mechanism comprises an elongated strip-shaped body 50 with an adjustable height. For example, the elongated strip-shaped body 50 consists of an upper half section and a lower half section, which are threadedly connected. A disk holder 51 is also provided at the lower end of the elongated strip-shaped body 50, so that the positioning mechanism can be stably supported and placed.

In some embodiments, the device for high pressure and steaming heat-induced antigen retrieval comprises a drip tray 60, wherein the drip tray 60 is a tray body which has an opening at the top and in which the retrieval solution 70 for providing steam is contained. The retrieval solution 70 for immersing tissue 200 between the slide glass 42 and the cover glass 43 is consistent with the retrieval solution 70 in the drip tray, i.e., they are the same retrieval solution 70.

When the retrieval solution for providing steam is not consistent with the retrieval solution for immersing tissue, for example, the retrieval solution for providing steam is water or other solution, the steam is formed and then densely distributed around the slide glass and the cover glass, including between the slide glass and the cover glass, the steam will dilute the retrieval solution for immersing tissue, so that the concentration of the retrieval solution cannot meet the requirements, and the retrieval effect cannot meet the set requirements. Therefore, in the embodiment, the same retrieval solution 70 is used. Even if the steam is distributed around the retrieval solution 70 of the tissue 200, there is no dilution effect because the two substances are the same.

There are many kinds of tissue to be retrieved. For larger tissue, the area occupied on the slide glass is also larger. When the tissue with a large area is immersed in the retrieval solution, the edge of the tissue is close to the edge of the slide glass because of its large area. There is only small amount of retrieval solution here, such as the location point 201 in FIG. 7. Since the amount of retrieval solution around the location point 201 is small, it is easy to be evaporated under high temperature, and is also easy to be diluted. Therefore, in the present disclosure, the retrieval solution 70 for immersing the tissue 200 is set to be consistent with the retrieval solution 70 in the drip tray 60, which can reduce or even avoid the impact of dilution on the tissue here.

In some embodiments, the retrieval solution 70 for immersing the tissue 200 between the slide glass 42 and the cover glass 43 and the retrieval solution 70 in the drip tray 60 are both sodium citrate retrieval solution 70.

The embodiments of the present disclosure also provide a method for high pressure and steaming heat-induced antigen retrieval, which comprises the following steps.

The method comprises providing a slide glass 42, placing tissue 200 to be retrieved on the slide glass 42, dripping retrieval solution 70 on the tissue 200 until the retrieval solution 70 immerses the tissue 200, and covering the cover glass 43; in some embodiments, in this step, a slide glass 42 carrying tissue 200 can also be directly provided.

The method also comprises placing the two ends of the slide glass 42 with the tissue 200 and the cover glass 43 on the left half body 411 and the right half body 412 of the slice fixation box 41.

The method also comprises placing the slide loading tray 30 in a bottom layer in an external high-pressure heating device by passing through an elongated strip-shaped body 50 so as to be supported by the support mechanism 10, injecting retrieval solution 70 in the external high-pressure heating device, and placing a plurality of the slice fixation boxes 41 on the slide loading trays 30. When the slide loading trays 30 are numbered correspondingly, the slide loading tray 30 in a bottom layer can be a slide loading tray 30 with a selected number (for example, the slide loading tray No. 1). When the slide loading trays 30 are not numbered, the slide loading tray 30 in a bottom layer can be any one slide loading tray 30 taken out from a plurality of slide loading trays.

The method also comprises placing a slide loading tray 30 and a slice fixation box 41 in the next upper layer sequentially. When the slide loading trays 30 are numbered correspondingly, the slide loading tray 30 in the next upper layer can be a slide loading tray 30 with a selected number (for example, the slide loading tray No. 2); and the slide loading tray 30 and the slice fixation box 41 in the next upper layer are placed sequentially, for example, the slide loading trays and the slice fixation boxes are sequentially placed in the order of No. 2, No. 3, No. 4 and so forth, after placing the slide loading tray 30 in one layer and before placing the slide loading tray 30 in the upper layer next to this one layer, several slice fixation boxes 41 are placed on the slide loading tray 30 in the upper layer. When the slide loading trays 30 are not numbered, the slide loading tray 30 in the next upper layer can be any one slide loading tray 30 taken out from the remaining slide loading trays 30 that are not placed yet.

The method also comprises starting the external high-pressure heating device to provide high-pressure and high-temperature hot steam to retrieve the tissue 200. That is, the external high-pressure heating device is in a stable working state, providing hot steam at a pressure above a pressure threshold and a temperature above a temperature threshold, so as to retrieve the tissue 200; wherein the temperature threshold is, for example, 120° C., and the pressure threshold is 90 Kpa.

In some embodiments, the retrieval solution 70 injected into the external high-pressure heating device is consistent with the retrieval solution 70 for immersing tissue 200 between the slide glass 42 and the cover glass 73.

In some embodiments, the method for high pressure and steaming heat-induced antigen retrieval also includes the steps of, slicing, dewaxing and hydrating the tissue 200 before the heat-induced retrieval of the tissue 200, and the steps of antigen-antibody binding, redyeing, transparency, sealing, photographing and preservation after the retrieval of tissue 200.

In the following, a preferred embodiment is described. The retrieval device adopted in this embodiment is the aforesaid device for high pressure and steaming heat-induced antigen retrieval, the retrieval method adopted in this embodiment is a method for high pressure and steaming heat-induced antigen retrieval, and the specific implementation steps are as follows.

(I). Slicing the tissue 200: comprising cooling, labeling, slicing, slice spreading, slice fishing and slice baking.

### 1. Cooling

A wax block has been stored in a refrigerator at 4° C. overnight. Before slicing, the wax block was buried in crushed ice, and was taken out just before slicing. When the cut tissue 200 was broken, the wax block must be put into the crushed ice again to be cooled for 3 minutes, and then the slicing was continued.

### 2. Labeling

Before slicing, the wax block code and sample information were labeled on the slide glasses 42, and when fishing the slices, the wax block code and sample information shall correspond thereto one by one.

### 3. Slicing

During slicing, the blade was divided into three sections of A, B and C from left to right, the wax block could be retrieved by section A for the first time, and the required tissue 200 could be cut by section B and section C in turn after trimming and leveling; and the slice thickness of the tissue 200 was 3 μm or 5 μm according to the properties of the tissue 200.

### 4. Slice Spreading

The water temperature of the water tank was adjusted to 40° C., and the slices cannot be fished until the slices floated on the water surface and were fully spreading without corrugation.

### 5. Slice Fishing

A plurality of connected tissue 200 samples were separated by forceps, the front face of the slide glass 42 forms a 45° angle with the surface of the water, and after the slide glass 42 was deep under the tissue 200, positioning the tissue 200 to ensure that it was within a suitable range of the slide glass 42, so that the tissue 200 could be fished.

### 6. Slice Baking

The slide glasses 42 attached with the tissue 200 were placed in parallel on a baking machine and baked for 3 minutes. When there were no residual water droplets on the slide glasses 42, the slide glasses 42 were inserted into a slide holder and placed in an oven at 60° C. overnight.

(II). Dewaxing and Hydration

1. The slide glass 42 attached with the tissue 200 was immersed in the first xylene solution for 6 minutes and then taken out;

2. Immersed in the second xylene solution for 6 minutes and then taken out;

3. Immersed in the third xylene solution for 6 minutes and then taken out;

4. Immersed in the first 100% ethanol for 5 minutes and then taken out;

5. Immersed in the second 100% ethanol for 5 minutes and then taken out;

6. Immersed in the first 95% ethanol for 3 minutes and then taken out;

7. Immersed in the second 95% ethanol for 3 minutes and then taken out;

8. Immersed in 85% ethanol for 2 minutes and then taken out;

9. Immersed in 75% ethanol for 1 minute and then taken out;

10. Flushed by flowing tap water for 5 minutes;

11. Immersed in distilled water for 1 minute;

12. The slide 42 attached with the tissue 200 was transferred into the sodium citrate retrieval solution 70.

(III). Steaming Heat-Induced Antigen Retrieval:

1. 300 ml sodium citrate antigen retrieval solution 70 with pH 6.0 was added into the pressure cooker 100 (with a diameter of 20 cm and a height of 13 cm; or other size), wherein the sodium citrate antigen retrieval solution 70 may be prepared from one bag of sodium citrate stock solution and 1,000 ml of pure water.

2. The lower support mechanism 10 was put into the retrieval solution 70 after height adjustment (the upper end of the lower support mechanism 10 was 5 cm above the surface of the retrieval solution 70).

3. One slide loading tray 30 was inserted through the elongated strip-shaped body 50 and placed on the lower support mechanism 10. If one slide loading tray 30 was not enough to place all the slices of tissue 200, the second slide loading tray 30 was inserted through the elongated strip-shaped body 50 to be clamped in the positioning counter bore 32, and the upright post 20 supported the second slide loading tray to be placed steadily above the first slide loading tray 30.

4. An induction cooker was started with the power modulated to 300 W to heat the pressure cooker 100 slowly.

5. 1 ml of citrate retrieval solution 70 was dripped on the slide glass 42, the cover glass 43 was covered, air bubbles were evacuated so that the cover glass 43 and the slide glass 42 were closely attached to each other, the slide glass 42 was gently inserted into the slice fixation box 41 with the label end placed on the higher end of the box and the label facing upwards, and the slice fixation box 41 was laid horizontally on the slide loading tray 30. In some embodiments, the heights of the stepped grooves 413 in the left half body 411 and the right half body 412 of the slice fixation box 41 are set differently, wherein one end is a higher end and the other end is a lower end. When the slide 42 is inserted into the slice fixation box 41, the label end is placed at the higher end. In this way, the stepped groove 413 at the lower end has a limiting effect on the cover glass 43, which can prevent the cover glass 43 from displacing and sliding due to the effect of steam.

6. The pot cover was covered; the power was adjusted to 2,100 W and reduced to 1,800 W after the pressure valve of the pressure cooker was lifted. After timing for 2 minutes, the steam of the retrieval solution 70 was discharged from the bottom of the pressure cooker 100 through large exhaust holes and small exhaust holes 31, the oven was closed, and the cooker cover was opened after cooling for 10 minutes at room temperature, and cooling was continued for 5 minutes.

7. A small amount of sodium citrate retrieval solution 70 at room temperature was poured onto the slide glass 42 to cool the slices; the slide loading tray 30 was taken out by the slide loading tray gripper to take out the slice, the cover glass 43 was gently taken away, the slide glass was immersed in distilled water for 3 minutes, immersed in 3% H₂O₂ for 10 minutes, immersed in the PBS (phosphate buffer saline) for 6 minutes, and the slide glass was transferred to a wet box.

(IV). Antigen-antibody binding: the slide glass was quickly swung to remove solution from the tissue; the residual solution around the tissue 200 on the slide glass 42 was dried by adoption of filter paper, and it shall be kept in mind that the filter paper cannot touch the tissue. 5% BSA (bovine serum albumin) (40 μl/piece of tissue, immunohistochemistry pen was adopted to draw circles around the tissue 200 in advance to avoid antibody displacement) was added at room temperature and put into a wet box for 20 minutes. The first antibody (40 μl/piece of tissue) was added after 20 minutes and put into a refrigerator at 4° C. overnight; PBS was used for washing for three times at an interval of 3 minutes, the solution around the tissue was dried by adoption of the filter paper; a reaction enhancer was added for 20 minutes (40 μl/piece of tissue), PBS was used to wash for three times at an interval of 4 minutes, the solution around the tissue was dried by adoption of the filter paper; the second antibody was added and put into an oven at 37° C. for 30 minutes, PBS was used for washing for three times at an interval of 3 minutes, the solution around the tissue was dried by adoption of the filter paper; the DAB (3,3′-Diaminobenzidine tetrahydrochloride) chromogenic solution (40 μl) was added and observed under a microscope, when the tissue appeared light brown, and was washed with distilled water immediately until DAB was completely washed away, the slices were collected, the tap water was used to continue to wash for 5 minutes, and the DAB waste solution was recovered.

(V). Redyeing: dyeing with hematoxylin staining solution for 1 minute, washing with tap water for 1 minute, differentiating with 0.6% hydrochloric acid alcohol for 1 second, and washing with tap water for 1 minute to return blue.

(VI). Dehydration, transparency and sealing the slice: 75% ethanol for 1 minute, 85% ethanol for 1 minute, 95% ethanol for 1 minute, 100% ethanol I for 1 minute, 100% ethanol II for 1 minute, xylene I for 2 minutes, xylene II for 2 minutes, neutral gum used for sealing, and airing slices.

(VII). Taking photos and making preservation

Alcohol and xylene should be replaced in time according to the number of films (about 300).

The modules or units in the device of the embodiment of the present disclosure can be combined, divided and deleted according to actual needs.

The above disclosed embodiments are only preferred embodiments of the present disclosure and, of course, should not limit the scope of the present disclosure. Those ordinary skilled in the art can understand all or part of the process for realizing the above embodiments, and the equivalent changes made according to the claims of the present disclosure still belong to the scope of the present disclosure.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A device for high pressure and steaming heat-induced antigen retrieval, comprising a lower support mechanism, an isolation mechanism, a loading mechanism, a slide loading mechanism and a positioning mechanism;
wherein the lower support mechanism has a lower end that is placed inside an external high-pressure heating device, and an upper end at which the loading mechanism is placed; the loading mechanism comprises at least two slide loading trays; the isolation mechanism comprises at least one upright post, the at least two slide loading trays are arranged sequentially from bottom to top; the upright post is arranged between two adjacent slide loading trays; the slide loading mechanism comprises at least one slice fixation box, and a slide glass and a cover glass arranged in the slice fixation box; the cover glass is placed on an upper surface of the slide glass, and tissue to be retrieved and retrieval solution are placed between the slide glass and the cover glass; a limiting hole is formed in a middle of each slide loading tray, the positioning mechanism has a lower end that is inserted through the limiting hole of each slide loading tray, and an upper end that is located above a slide loading tray in a top layer, and a plurality of air holes are formed on the slide loading tray.

2. The device for high pressure and steaming heat-induced antigen retrieval according to claim 1, wherein an upper surface and a lower surface of the slide loading tray are provided with inward concave positioning counter bores close to edges, and an end of the upright post is clamped in one of the positioning counter bores.

3. The device for high pressure and steaming heat-induced antigen retrieval according to claim 1, wherein the slice fixation box comprises a left half body and a right half body which are oppositely arranged; each of the left half body and the right half body is provided with a stepped groove for placing an end of the slide glass; there is a distance between a bottom wall of the stepped groove and an upper surface of the slide loading tray, so that the slide glass between the left half body and the right half body does not contact the upper surface of the slide loading tray.

4. The device for high pressure and steaming heat-induced antigen retrieval according to claim 3, wherein the stepped groove has a height of at least 1 mm.

5. The device for high pressure and steaming heat-induced antigen retrieval according to claim 3, wherein an upper surface of the slide glass and a lower surface of the cover glass are oppositely arranged, and are both smooth flat surfaces.

6. The device for high pressure and steaming heat-induced antigen retrieval according to claim 1, wherein the positioning mechanism comprises an elongated strip-shaped body that can be extended or retracted with an adjustable height, and the upright post of the lower support mechanism can be extended or retracted with an adjustable height.

7. The device for high pressure and steaming heat-induced antigen retrieval according to claim 1, further comprising a drip tray that is a tray body, which has an opening at a top and in which retrieval solution for providing steam is contained, wherein retrieval solution for immersing tissue between the slide glass and the cover glass is consistent with the retrieval solution in the drip tray.

8. The device for high pressure and steaming heat-induced antigen retrieval according to claim 7, wherein the retrieval solution for immersing tissue between the slide glass and the cover glass and the retrieval solution in the drip tray are both sodium citrate retrieval solution.

9. A method for high pressure and steaming heat-induced antigen retrieval, which is applied in the device for high pressure and steaming heat-induced antigen retrieval according to claim 3, wherein the method for high pressure and steaming heat-induced antigen retrieval includes the following steps:
dripping 1 ml of retrieval solution onto the slide glass that carries tissue, covering the cover glass, and placing two ends of the cover glass on the left half body and the right half body of the slice fixation box;
placing a slide loading tray in a bottom layer in an external high-pressure heating device, injecting retrieval solution in the external high-pressure heating device, and placing on the slide loading tray a plurality of slice fixation boxes on which slide glasses are placed;
placing a slide loading tray and a slice fixation box, on which a slide glass is placed, in the next upper layer sequentially;
starting the external high-pressure heating device to provide the tissue with hot steam at a pressure above a pressure threshold and a temperature above a temperature threshold, to retrieve the tissue.

10. The method for high pressure and steaming heat-induced antigen retrieval according to claim 9, wherein retrieval solution injected in the external high-pressure heating device is consistent with retrieval solution for immersing the tissue between the slide glass and the cover glass.
